(19) United States
(12) Patent Application Publication
(10) Pub. No.: US 2006/0133979 A1
(43) Pub. Date: Jun. 22, 2006

(54) Apparatus and method for manufacturing nano carbon

(76) Inventors: Takeshi Azami, Tokyo (JP); Takashi Manako, Tokyo (JP); Tsutomu Yoshitake, Tokyo (JP); Yoshimi Kubo, Tokyo (JP); Sumio Iijima, Tokyo (JP); Masako Yudasaka, Tokyo (JP); Daisuke Kasuya, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/544,133

(22) PCT Filed: Feb. 10, 2004
(86) PCT No.: PCT/JP04/01381

§ 371 Date: Aug. 2, 2005

(30) Foreign Application Priority Data
Feb. 10, 2003 (JP) 2003-031927

(51) Int. Cl. C01B 31/02; B01J 19/08

(52) U.S. Cl. 423/445 B; 977/844; 422/186

(57) ABSTRACT

A production method and a production apparatus for stable mass production of nanocarbon are provided. In a production chamber (107), a graphite rod (101) having a cylindrical shape is fixed to a rotation apparatus (115), and is made to be capable of rotating with the length direction of the graphite rod (101) serving as an axis, and also moving to the right or the left in the length direction. The side surface of the graphite rod (101) is irradiated with a laser beam (103) from a laser light source (111), and a nanocarbon collecting chamber (119) is disposed in the direction of generation of plumes (109). On the other hand, the surface irradiated with the laser beam (103) among the side surfaces of the graphite rod (101) is speedily rotated by the rotation apparatus (115) and is flattened by a cutting tool (105). Cut dusts of the graphite rod (101) generated by the cutting tool (105) are collected into a cut graphite collecting chamber (121) and separated from the generated carbon nanohorn aggregates (117).

### FIELD OF THE INVENTION

The present invention relates to a nanocarbon production apparatus and a nanocarbon production method.

### DESCRIPTION OF THE RELATED ART

In recent years, industrial application of nanocarbon is eagerly studied. Nanocarbon refers to a carbon substance having a fine structure of nano-scale, as represented by carbon nanotubes and carbon nanohorns and the like. Among these, a carbon nanohorn has a structure of tubular shape in which one end of a carbon nanotube made of a cylindrically rolled graphite sheet has a conical shape. From its specific properties, application to various fields of the art is expected. Carbon nanohorns are typically aggregated in a form such that the conical parts protrude to the surface as horns (horns) with the tubes serving as a center by the van der Waals force acting among individual conical parts.

It is reported that carbon nanohorn aggregates are produced by the laser evaporation method by which a source material carbon substance (hereafter, referred to as graphite target in some cases) is irradiated with a laser beam in an inert gas atmosphere (Patent Document 1).

Patent Document 1: Japanese Patent Publication Laid-Open No. 2001-64004

### SUMMARY OF THE INVENTION

The present inventors have made eager studies on a technique for stable mass production of nanocarbon by the laser evaporation method. As a result of this, the following knowledge has been found out.

By the laser evaporation method, the surface of a graphite target once irradiated with a laser beam is roughened. This is explained by taking as an example a case in which a side surface of a graphite target having a cylindrical shape is irradiated with a laser beam. FIG. 3 is a view that exemplifies the manner of this in the case in which a graphite target having a cylindrical shape is used. FIG. 3(c) is a cross-sectional view perpendicular to the length direction of a graphite rod 101 when it is irradiated with a laser beam 103 for the first time, and FIG. 3(a) is an enlarged view of a laser beam 103 irradiated part.

As shown in FIG. 3(a) and FIG. 3(c), since the side surface irradiated with the laser beam 103 for the first time is a flat surface, a plume 109 is generated in a certain definite direction. On the other hand, FIG. 3(d) is a view illustrating a manner in which the side surface after irradiation with the laser beam 103 for one or more times is irradiated with the laser beam 103 again in FIG. 3(c). FIG. 3(b) is an enlarged view of the laser beam 103 irradiated part. As shown in FIGS. 3(b) and 3(d), once irradiated with the laser beam 103, the side surface of the graphite rod 101 is roughened. When the surface-roughened position is irradiated with the laser beam 103 again, a fluctuation in the power density at the irradiated position is generated, and also disturbance in the direction of the plume 109 generation is generated.

It has been found out that a surface once irradiated with the laser beam 103 is roughened, so that when the surface is irradiated with the laser beam 103 again, there is change in the irradiation angle of the laser beam 103 and in the area irradiated with light on the graphite rod 101 side surface, and there is change in the power density of the laser beam 103 on the graphite rod 101 side surface. For this reason, stable mass production of carbon nanohorn aggregates has been difficult.

In this manner, no method for continuous and stable production of carbon nanohorn aggregates has been conventionally found, so that development of mass production technique is a critical issue in putting the carbon nanohorn aggregates into practical use.

The present invention has been made in view of the above circumstances, and an object thereof is to provide a production method and a production apparatus for stable mass production of carbon nanohorn aggregates. Also, another object of the present invention is to provide a production method and a production apparatus for stable mass production of nanocarbon.

According to the present invention, there is provided a nanocarbon production method comprising: irradiating a surface of a graphite target with light, collecting carbon vapor evaporated from the graphite target as nanocarbon, and flattening the surface of the graphite target irradiated with light; and irradiating the graphite target surface that is flattened with light again and collecting carbon vapor evaporated from the graphite target as nanocarbon.

Also, according to the present invention, there is provided a nanocarbon production apparatus comprising: a light source for irradiating a surface of a graphite target with light; a surface processing unit for flattening the surface of the graphite target irradiated with light; and a collecting unit for collecting carbon vapor evaporated from the graphite target by irradiation with light, as nanocarbon.

In the present invention, “flattening” refers to a process of relatively reducing the degree of concavity and convexity on the surface of the graphite target as compared with that before the process. According to the nanocarbon production method of the present invention, though the graphite target surface is roughened by irradiation with light, this is flattened and the flattened position is irradiated with light again. Therefore, the graphite target surface irradiated with light is always maintained in a flat state. Therefore, the power density at the irradiated site of the graphite target surface is kept constant, thereby enabling stable mass synthesis of nanocarbon. Here, in the present specification, the “power density” is assumed to indicate the power density of light with which the graphite target surface is actually irradiated, that is, the power density at the light-irradiated position of the graphite target surface.

According to the present invention, there is provided a nanocarbon production method comprising: irradiating a surface of a graphite target having a cylindrical shape with light while rotating the graphite target around a central axis, collecting carbon vapor evaporated from the graphite target as nanocarbon, and flattening the surface of the graphite target irradiated with light; and irradiating the surface that is flattened with light again while rotating the graphite target around the central axis, and collecting carbon vapor evaporated from the graphite target as nanocarbon.

Also, according to the present invention, there is provided a nanocarbon production apparatus comprising: a target holding unit that holds a graphite target having a cylindrical shape and rotates the graphite target around a central axis; a light source for irradiating a surface of the graphite target with light; a surface processing unit for flattening the surface of the graphite target irradiated with light; and a collecting unit for collecting carbon vapor evaporated from the graphite target by irradiation with light, as nanocarbon.

According to the present invention, a graphite target having a cylindrical shape is rotated around a central axis, so that the side surface roughened by, for instance, irradiation with light is flattened. Then the flattened side surface is again irradiated with light. Thus, by performing the irradiation with light and flattening while rotating the graphite target having a cylindrical shape, nanocarbon can be produced continuously and efficiently in a large amount.

Here, in the present invention, the “central axis” refers to the axis that passes through the center of the cross section perpendicular to the length direction of the graphite target having a cylindrical shape and is horizontal to the length direction. Also, as a graphite target having a cylindrical shape, a graphite rod can be used, for example. Here, the “graphite rod” refers to a graphite target formed into a rod shape. As long as it has a rod shape, it does not matter whether it is hollow or solid. Also, the surface of the graphite target having a cylindrical shape that is irradiated with light is preferably a side surface of the graphite target having a cylindrical shape, as described above. Here, the “side surface of a graphite target having a cylindrical shape” indicates the curved surface (cylindrical surface) parallel to the length direction of the cylinder.

According to the present invention, there is provided a nanocarbon production apparatus comprising: a target holding unit that holds a graphite target having a flat plate shape and rotates the graphite target by 180 degrees in a normal line direction of a surface; a light source for irradiating a surface of the graphite target with light; a surface processing unit for flattening the surface of said graphite target irradiated with light; and a collecting unit for collecting carbon vapor evaporated from the graphite target by irradiation with light, as nanocarbon.

Also, according to the present invention, there is provided a nanocarbon production method comprising: irradiating a surface of a graphite target having a flat plate shape with light and collecting carbon vapor evaporated from the graphite target as nanocarbon; flattening the surface of the graphite target irradiated with light after the graphite target irradiated with light is rotated by 180 degrees in a normal line direction of the surface; and irradiating the flattened surface with light again and collecting carbon vapor evaporated from the graphite target as nanocarbon.

In the present invention, after one surface of a graphite target having a flat plate shape is irradiated with light, this is reversed and the other surface is irradiated with light. Then one surface can be flattened while the other surface is being irradiated with light. The flattened one surface is subjected to the second time irradiation with light after the graphite target is reversed again. During the second time irradiation with light, the other surface is flattened. Thus, the present invention is constituted in such a manner that irradiation with light is carried out while reversing the light-irradiation surface of the flat-plate-shaped graphite target and, while one surface is being irradiated with light, the other surface can be flattened. For this reason, with the use of a graphite target having a flat plate shape, nanocarbon having desired properties can be efficiently and stably produced at a high purity.

In the nanocarbon production method of the present invention, irradiation with light may be carried out while moving an irradiation position of light in the irradiating the surface of the graphite target with light and in the irradiating the graphite target surface with light again.

Also, the nanocarbon production apparatus of the present invention may further comprise a movement unit that moves a relative position of the graphite target relative to the light source. As the movement unit, for example, in the case of irradiating light while rotating the graphite target having a cylindrical shape around a central axis, a mode can be adopted that moves the position of the graphite target so as to move the irradiated position in the length direction of the graphite target.

By doing so, the steps of irradiating with light, flattening, and irradiating with light again can be carried out more efficiently and continuously, thereby enabling efficient mass production of nanocarbon.

For example, according to the present invention, there is provided a nanocarbon production method comprising: disposing a graphite target in a chamber, irradiating a surface of the graphite target with light while moving an irradiation position, collecting carbon vapor evaporated from the graphite target as nanocarbon, and flattening the surface of the graphite target irradiated with light; and irradiating the flattened surface of the graphite target with light again while moving the irradiation position without taking the graphite target out from the chamber, and collecting carbon vapor evaporated from the graphite target as nanocarbon.

In the nanocarbon production method of the present invention, the flattening the surface irradiated with light may comprise removing a part of the surface of the graphite target.

Also, in the nanocarbon production apparatus of the present invention, the surface processing unit may remove apart of the surface of the graphite target at a position different from the irradiation position of the light.

By doing so, the graphite target surface roughened by irradiating with light may be efficiently flattened. As long as the graphite target surface may be flattened, the method of removing a part thereof is not particularly limited; however, cutting, grinding, polishing, and the like can be raised as an example.

The nanocarbon production apparatus of the present invention may further comprise dust collecting unit for collecting dust of the graphite target generated in the surface processing unit. By doing so, the cut dust generated by cutting of the graphite target surface may be efficiently separated from the generated nanocarbon and collected.

In the nanocarbon production method of the present invention, the irradiating with light may comprise irradiating with a laser beam. By doing so, the wavelength and direction of light may be made constant, so that the condition of irradiating the graphite target surface with light may be controlled in a good precision, thus enabling selective production of a desired nanocarbon.

In the nanocarbon production method of the present invention, the collecting the nanocarbon may comprise collecting carbon nanohorn aggregates.

Also, in the nanocarbon production apparatus of the present invention, the nanocarbon may be carbon nanohorn aggregates.

By doing so, mass synthesis of carbon nanohorn aggregates can be carried out efficiently. In the present invention, the carbon nanohorn constituting the carbon nanohorn aggregates may be either a monolayer carbon nanohorn or a multi-layer carbon nanohorn.

Also, carbon nanotubes can be collected as the nanocarbon.

As described above, according to the present invention, by flattening a surface of a graphite target irradiated with light, irradiating the flattened surface of the graphite target with light again, and collecting carbon vapor evaporated from the graphite target as nanocarbon, the nanocarbon can be stably produced in a large amount. Also, according to the present invention, carbon nanohorn aggregates can be stably produced in a large amount.

### BRIEF DESCRIPTION OF THE DRAWINGS

The above-described objects and other objects, features, and advantages will be made more apparent from the preferable embodiments described hereafter and the following drawings associated therewith.

FIG. 1 is a view illustrating one example of a configuration of a nanocarbon production apparatus according to the present invention.

FIG. 2 is a view for describing the configuration of the nanocarbon production apparatus of FIG. 1.

FIG. 3 is a view for describing a laser beam irradiation position of a solid carbon elemental substance.

FIG. 4 is a view showing a relationship between the number of laser beam irradiation times and the yield of carbon nanohorn aggregates.

FIG. 5 is a view illustrating one example of a configuration of a nanocarbon production apparatus according to the present invention.

FIG. 6 is a view illustrating one example of a configuration of a nanocarbon production apparatus according to the present invention.

FIG. 7 is a view describing one example of a nanocarbon production method according to the present invention.

### DETAILED DESCRIPTION OF THE INVENTION

Hereafter, preferable embodiments of a nanocarbon production apparatus and a production method according to the present invention will be described by taking as an example a case in which nanocarbon is carbon nanohorn aggregates.

(First Embodiment)

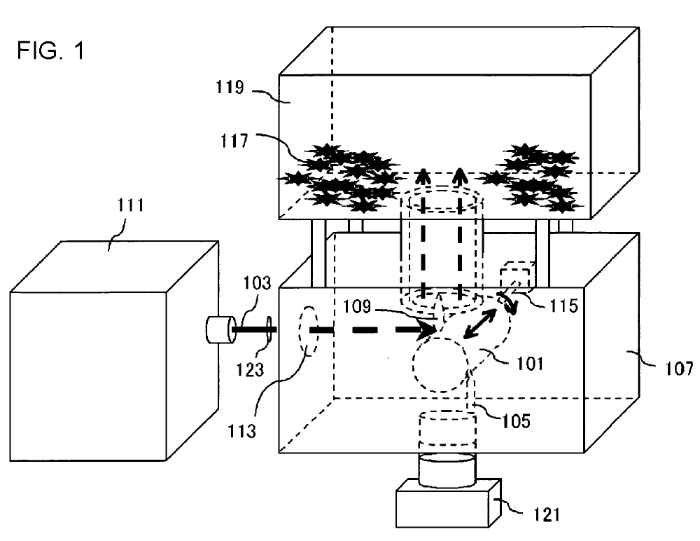

FIG. 1 is a view illustrating one example of a configuration of a nanocarbon production apparatus. The production apparatus of FIG. 1 comproses three chambers of a production chamber 107, a nanocarbon collecting chamber 119, and a cut graphite collecting chamber 121, as well as a laser light source 111 for applying a laser beam 103 into the production chamber 107 through a laser beam window 113, and a lens 123 for condensing the laser beam 103.

As a solid carbon single element substance acting as a target of the laser beam 103 irradiation, a graphite rod 101 is used. The graphite rod 101 is fixed to a rotation apparatus 115, and is rotatable around a central axis serving as an axis. Also, the graphite rod 101 is capable of positional movement. A side surface of the graphite rod 101 is irradiated with the laser beam 103 from the laser light source 111. In FIG. 1, the position a little down from the top of the side surface of the graphite rod 101 is irradiated with the laser beam 103, and a plume 109 is generated in the normal line direction of the irradiated surface. In the apparatus of FIG. 1, since the nanocarbon collecting chamber 119 is disposed in the direction substantially straightly above the direction of the plume 109 generation, the generated carbon nanohorn aggregates 117 are collected into the nanocarbon collecting chamber 119.

Since the graphite rod 101 is rotating by the rotation apparatus 115, the region irradiated with the laser beam 103 is led to a position where a cutting tool 105 contacts with the graphite rod 101, and is cut at this position thereby to flatten the side surface. The cut dust of the graphite rod 101 generated by the cutting tool 105 is collected into the cut graphite collecting chamber 121 and is separated from the generated carbon nanohorn aggregates 117.

In the apparatus of FIG. 1, the positions of the laser light source 111 and the cutting tool 105 are fixed. Since the graphite rod 101 rotates around its central axis, the position irradiated with the laser beam 103 quickly moves to the position contacting with the cutting tool 105, and is flattened by the cutting tool 105. During this time, the graphite rod 101 moves in its longitudinal direction to change the position irradiated with the laser beam 103. The position of cutting by the cutting tool 105 also changes in accordance with the change in the irradiated position.

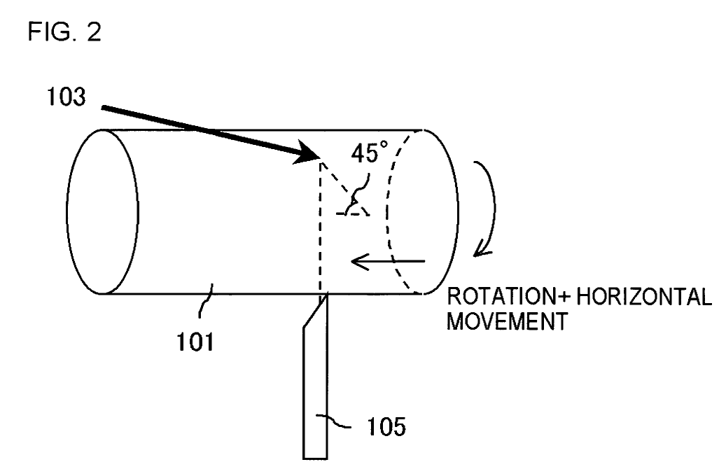

The manner of this is shown in FIG. 2. FIG. 2 is a view showing position relationship between the laser beam 103, the cutting tool 105, and the graphite rod 101 in the nanocarbon production apparatus of FIG. 1. As shown in FIG. 2, the laser beam 103 is applied so that the angle formed by the horizontal plane and the line segment connecting the irradiated position to the center of the cross section perpendicular to the length direction of the graphite rod 101, that is, the irradiation angle in this embodiment, is constant. By sliding the graphite rod 101 in its length direction while keeping the irradiation angle of the laser beam 103 to be constant, the laser beam 103 can be continuously applied at a constant power density in the length direction of the graphite rod 101.

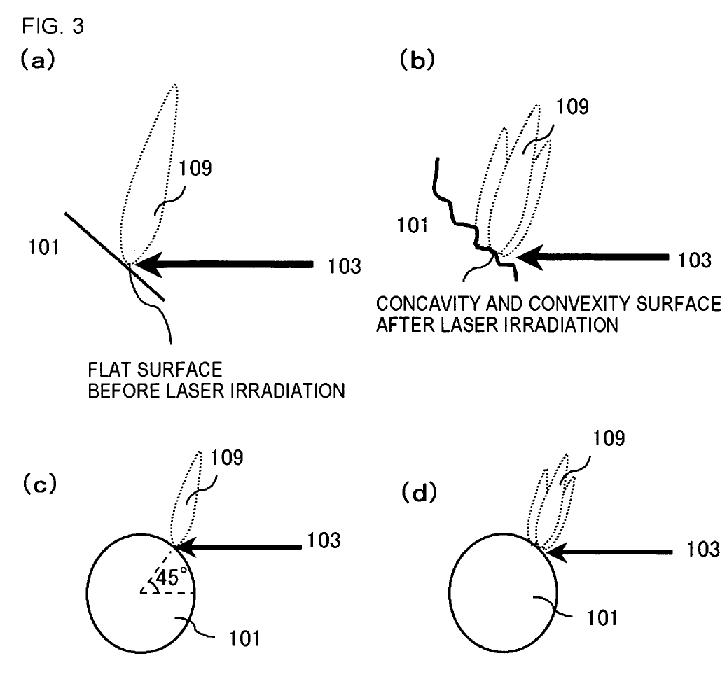

The irradiation angle during this time is preferably 30 degree or more and 60 degree or less. Here, as described above, in the present specification, the irradiation angle refers to the angle formed by the laser beam 103 and the line perpendicular to the surface of the graphite target at the position irradiated with the laser beam 103. When a graphite target having a cylindrical shape is used, the irradiation angle is the angle formed by the horizontal plane and the line segment connecting the irradiated position to the center of the circle in the cross section perpendicular to the length direction of the graphite rod 101, as shown in FIG. 2, FIG. 3(c), and FIG. 3(d).

By making this irradiation angle be 30 degree or more, the return light generated by reflection of the applied laser beam 103 can be restrained. Also, the generated plume 109 is prevented from directly hitting the lens 123 through the laser beam window 113. For this reason, this is effective in protecting the lens 123 and preventing adhesion of the carbon nanohorn aggregates 117 onto the laser beam window 113. Therefore, the power density of light applied to the graphite rod 101 can be stabilized, and the carbon nanohorn aggregates 117 can be produced stably at a high yield.

Also, by applying the laser beam 103 at 60 degree or less, the generation of amorphous carbon can be restrained, and the ratio of the carbon nanohorn aggregates 117 in the product, that is, the yield of the carbon nanohorn aggregates 117, can be improved. Further, it is particularly preferable that the irradiation angle is set to be 45 degree. By irradiating the beam at 45 degree, the ratio of the carbon nanohorn aggregates 117 in the product can be improved to a greater extent.

Also, since the nanocarbon production apparatus 347 has a configuration such that the side surface of the graphite rod 101 is irradiated with the laser beam 103, change can be easily made by changing the irradiation angle of the side surface in a state where the position of the lens 123 is fixed. For this reason, the power density can be made variable, and can be adjusted with certainty. For example, in the case in which the position of the lens 123 is fixed, the power density can be enhanced if the irradiation angle is set to be 30 degree, for example. Also, by setting the irradiation angle to be 60 degree, the power density can be controlled to be low.

Also, as described with the use of FIG. 3, once irradiated with the laser beam 103, the side surface of the graphite rod 101 is roughened. When the surface-roughened position is irradiated with the laser beam 103 again, fluctuation in the power density at the irradiated position is generated, and disturbance also in the direction of the plume 109 generation is generated. In this manner, when the surface once irradiated with the laser beam 103 is irradiated with the laser beam 103 again, the power density at the irradiation position cannot be made constant, thereby leading to decrease in the yield of carbon nanohorn aggregates 117.

Therefore, in the apparatus of FIG. 1, the cutting tool 105 is disposed below the graphite rod 101, as shown in FIG. 2. When the cutting tool 105 is disposed below the position irradiated with the laser beam 103, the side surface of the graphite rod 101 irradiated with the laser beam 103 is successively rotated to move to the position of the cutting tool 105 to be cut, so that the irradiated position can be continuously flattened. For this reason, the surface irradiated with the laser beam 103 is always a flat surface. Thus, the power density at the laser beam 103 irradiation position can be made constant even if the graphite rod 101 is not taken out of the production chamber 107 for carrying out a flattening process. Therefore, the laser beam 103 can be continuously applied while keeping the graphite rod 101 disposed in the production chamber 107, whereby the carbon nanohorn aggregates 117 can be efficiently produced in a large amount.

Also, when the laser beam 103 is applied as shown in FIG. 2, the plume 109 is generated upwards, so that the carbon nanohorn aggregates 117 are generated upwards. Therefore, when the cutting tool 105 is disposed below the graphite rod 101, the generated carbon nanohorn aggregates 117 can be efficiently separated from the cut dust of the graphite rod 101 which is a source material cut by the cutting tool 105.

Here, as shown in FIG. 2, the position of disposing the cutting tool 105 is preferably at the position equal to or a little behind the laser beam 103 irradiation position in the direction of movement of the graphite rod 101 parallel to the longitudinal axis. By doing so, one can prevent with certainty a defect such that the side surface of the graphite rod 101 is cut before being irradiated with the laser beam 103.

As described above, in the nanocarbon production apparatus of FIG. 1, the position irradiated with the laser beam 103 on the side surface of the graphite rod 101 having a cylindrical shape changes continuously, and the irradiation position is rotated to be flattened by the cutting tool 105, thereby enabling continuous production of carbon nanohorn aggregates 117. Also, since the graphite rod 101 acting as a graphite target can be repeatedly subjected to the laser beam 103 irradiation, the graphite rod 101 can be effectively used.

Next, a method of producing carbon nanohorn aggregates 117 using the production apparatus of FIG. 1 is specifically described.

In the production apparatus of FIG. 1, one can use a highly pure graphite, for example, a round-rod-shaped sintered carbon or compressed formed carbon or the like, as the graphite rod 101.

Also, as the laser beam 103, a laser beam such as a high-output-power CO₂ gas laser beam is used. Here, the materials of the laser beam window 113 and the lens 123 are suitably selected in accordance with the kind of the laser beam 103 to be used. For example, when a CO₂ gas laser beam is to be used, the material for the laser beam window 113 and the lens 123 can be ZnSe.

Irradiation of the graphite rod 101 with the laser beam 103 is carried out in an inert gas atmosphere such as rare gas of Ar, He, or the like, and in an atmosphere of, for example, 10³ Pa or higher and 10⁵ Pa or lower. Also, it is preferable to make the inert gas atmosphere after the gas in the inside of the production chamber 107 is discharged in advance to reduce the pressure to be, for example, 10⁻² Pa or lower.

Also, it is preferable to adjust the output power, the spot diameter, and the irradiation angle of the laser beam 103 so that the power density of the laser beam 103 on the side surface of the graphite rod 101 is approximately constant.

Also, it is preferable to adjust the output power, the spot diameter, and the irradiation angle of the laser beam 103 so that the power density of the laser beam 103 on the side surface of the graphite rod 101 is approximately constant, for example, 5 kW/cm² or more and 30 kW/cm² or less, for example, 20±10 kW/cm².

The output power of the laser beam 103 is set to be, for example, 1 kW or higher and 50 kW or lower. Also, the pulse width of the laser beam 103 is set to be, for example, 0.02 sec or more, preferably 0.5 sec or more, more preferably 0.75 sec or more. By doing so, the accumulated energy of the laser beam 103 applied to the surface of the graphite rod 101 can be sufficiently ensured. For this reason, the carbon nanohorn aggregates 117 can be efficiently produced. Also, the pulse width of the laser beam 103 is set to be, for example, 1.5 sec or less, preferably 1.25 sec or less. By doing so, the change of surface energy density caused by excessive heating of the graphite rod 101 surface can be restrained, which leads to decrease in the yield of the carbon nanohorn aggregates. The pulse width of the laser beam 103 is more preferably set to be 0.75 sec or more and 1 sec or less. By doing so, both the generation ratio and the yield of the carbon nanohorn aggregates 117 can be improved.

Also, the rest width in the laser beam 103 irradiation can be set to be, for example, 0.1 sec or more, and is preferably set to be 0.25 sec or more. By doing so more certainty, the overheating of the graphite rod 101 surface can be restrained.

Also, the spot diameter of the laser beam 103 on the graphite rod 101 side surface at the time of irradiation can be set to be, for example, 0.5 mm or more and 5 mm or less. Also, the preferable irradiation angle is as described above using FIG. 2.

During the laser beam 103 irradiation time, the graphite rod 101 is rotated by the rotation apparatus 115 at a constant speed in the circumferential direction. The rotation number is set to be, for example, 1 rpm or higher and 20 rpm or lower.

Also, it is preferable to move the spot of the laser beam 103 at a speed (circumferential speed) of, for example, 0.01 mm/sec or more and 55 mm/sec or less. For example, in the case of applying the laser beam 103 onto the surface of a graphite target having a diameter of 100 mm, the above-described circumferential speed can be realized by rotating the graphite rod 101 having a diameter of 100 mm at a constant speed in the circumferential direction with the use of the rotation apparatus 115 and setting the rotation number to be, for example, 0.01 rpm or higher and 10 rpm or lower. Here, the rotation direction of the graphite rod 101 is not particularly limited; however, it is preferable to rotate the graphite rod 101 in the direction away from the laser beam 103. By doing so, the carbon nanohorn aggregates 117 can be collected with more certainty.

The cutting tool 105 disposed below the graphite rod 101 is not particularly limited as long as it has a configuration capable of flattening the graphite rod 101 side surface, so that those with various shapes and properties can be used. Also, though the cutting tool 105 is used in the production apparatus of FIG. 1, various cutting members, for example, grinding members such as a file or, for example, a roller having a polishing paper (sand paper) disposed on an upper surface thereof, can be used. At this time, a member having a configuration such that the upper surface of the roller having a polishing paper disposed thereon is rotated around a central axis perpendicular to the surface so as to flatten the cylindrical surface of the graphite rod 101 can be used. Members may be used. Also, the position of disposing the cut graphite collecting chamber 121 is not particularly limited as long as it is a position where the cut dust generated by the cutting tool 105 can be collected, while being separated from the carbon nanohorn aggregates 117.

The apparatus of FIG. 1 has a configuration such that the soot-like substance obtained by irradiation with the laser beam 103 is collected into the nanocarbon collecting chamber 119; however, the soot-like substance can be collected by depositing on a suitable substrate or by a method of fine particle collecting using a dust bag. Also, an inert gas can be passed within the reaction container whereby the soot-like substance can be collected with the use of the stream of the inert gas.

The soot-like substance obtained by using the apparatus of FIG. 1 contains mainly the carbon nanohorn aggregates 117, and is collected, for example, as a substance containing carbon nanohorn aggregates 117 at 90 wt % or more.

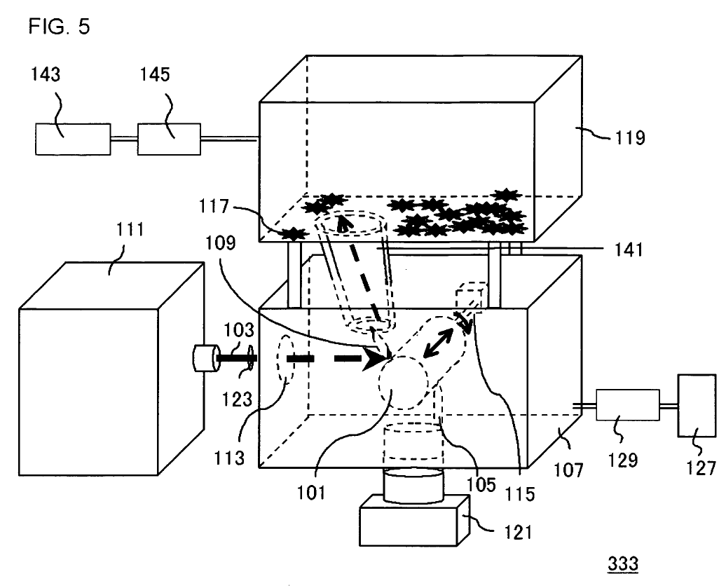

FIG. 5 is a view illustrating another configuration of a nanocarbon production apparatus according to this embodiment. The basic configuration of a nanocarbon production apparatus 333 of FIG. 5 is the same as that of the apparatus of FIG. 1; however, the position of irradiation with the laser beam 103 on the side surface of the graphite rod 101 is different. This makes the direction of the plume 109 generation be different, so that the extending direction of the transport piping 141 is different. Further, the nanocarbon production apparatus 333 comprises an inert gas supplying unit 127, a flowmeter 129, a vacuum pump 143, and a pressure gauge 145.

When the laser beam 103 is applied, the plume 109 is generated in the direction perpendicular to the tangential line of the graphite rod 101 at the position irradiated with the laser beam 103. In the nanocarbon production apparatus 333, the side surface of the graphite rod 101 is irradiated with the laser beam 103, and the irradiation angle is set to be 45 degree. Also, a transport piping 141 is disposed in the direction that forms an angle of 45 degree to the plumb line. For this reason, the apparatus has a configuration such that the transport piping 141 is disposed in the direction perpendicular to the tangential line of the graphite rod 101. Therefore, the carbon vapor can be efficiently led to the nanocarbon collecting chamber 119 to collect the carbon nanohorn aggregates 117. Also, since the irradiation angle is set to be 45 degree, the generation of return light is restrained as described above, so that the carbon nanohorn aggregates 117 can be stably produced with a high yield.

(Second Embodiment)

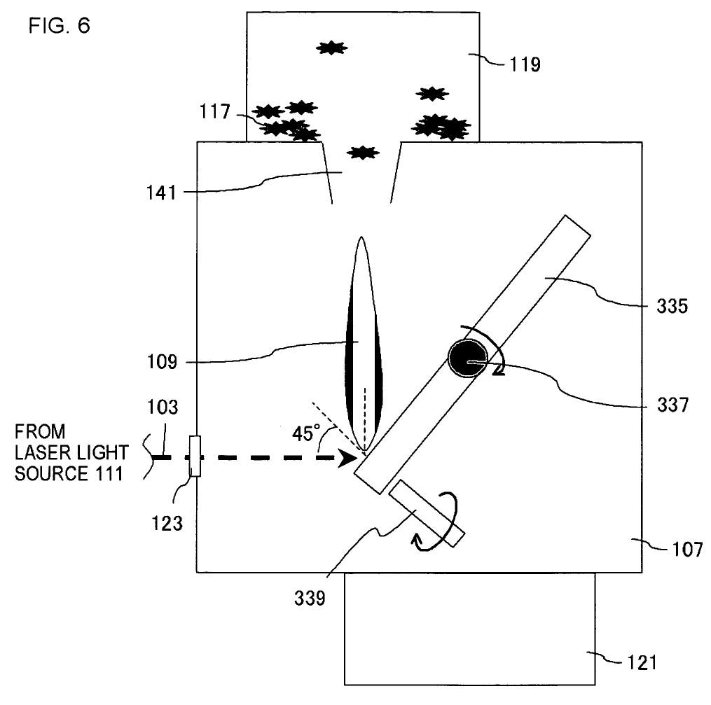

In the first embodiment, a graphite target having a cylindrical shape is used; however, a graphite target having a flat plate shape can be used as well. FIG. 6 is a cross-sectional schematic view illustrating a nanocarbon production apparatus 341 according to this embodiment.

The basic configuration of the nanocarbon production apparatus 341 is the same as those of the apparatus of FIG. 1 and FIG. 5; however, the apparatus is different in that the apparatus has a rotation apparatus 337 and a milling cutter 339.

The rotation apparatus 337 holds a graphite plate 335. Also, the rotation apparatus 337 includes a rotation mechanism that moves the graphite plate 335 in the surface direction and also reverses the irradiation surface.

The milling cutter 339 rotates around a longitudinal axis at a predetermined position, and cuts the surface of the graphite plate 335. When the milling cutter 339 is disposed below the graphite plate 335, the generated carbon nanohorn aggregates 117 can be efficiently separated from the cut dust that is cut by the milling cutter 339.

Here, the position of disposing the milling cutter 339 can be disposed at a position equal to or a little behind the irradiation position of the laser beam 103 in the direction of movement of the graphite plate 335 in the surface direction. By doing so, the back surface of the graphite plate 335 can be flattened with certainty while the laser beam 103 is applied.

It is sufficient that the graphite plate 335 can provide both surfaces thereof as an irradiation surface of the laser beam 103, and, for example, a graphite having a flat plate shape or a sheet shape can be used. The graphite plate 335 can have a shape such that the width of the surface thereof is larger than the thickness thereof. By doing so, the surface can be efficiently irradiated with the laser beam 103, so that the carbon nanohorn aggregates 117 can be efficiently produced.

Also, the graphite plate 335 can have a rectangular shape. By doing so, the adjustment of the movement direction of the graphite plate 335 can be easily carried out. For example, the carbon nanohorn aggregates 117 can be efficiently produced by applying the laser beam 103 while moving the graphite plate 335 along a straight line in the direction parallel to the longer side of the rectangle.

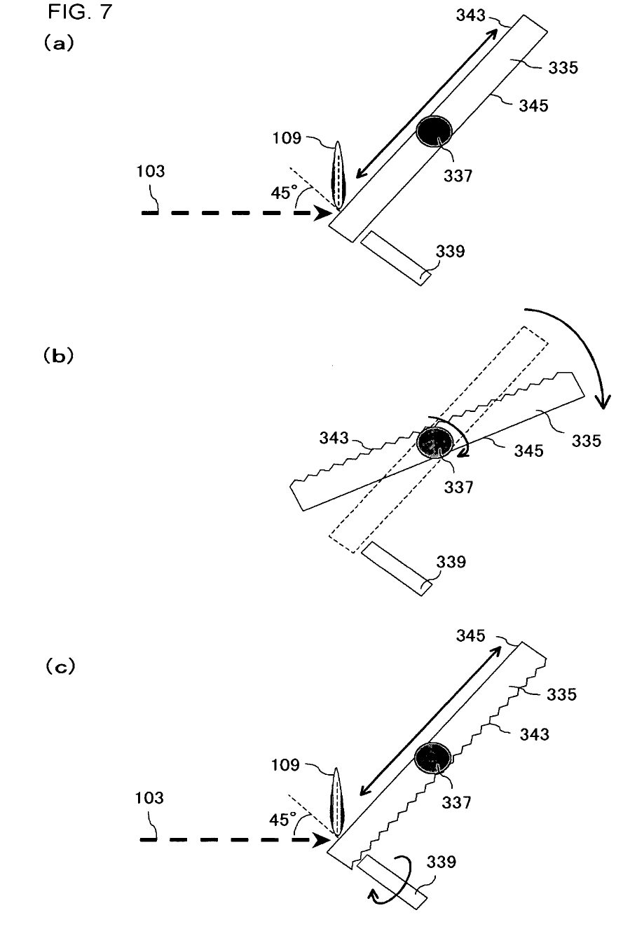

FIG. 7(a) to FIG. 7(c) are views describing the process of production of carbon nanohorn aggregates 117 using the nanocarbon production apparatus 341. Firstly, the laser beam 103 is applied while moving the graphite plate 335 in the direction horizontal to the surface (FIG. 7(a)). For example, the first surface 343 is irradiated while moving the graphite plate 335 in the longitudinal direction. During this period, since the laser beam 103 is applied to a predetermined position within the production chamber 107, the first surface 343 can be irradiated with the laser beam 103 while moving the irradiation position of the laser beam 103 by horizontally moving the graphite plate 335. The first surface 343 is roughened by irradiation with the laser beam 103.

Next, the graphite plate 335 is rotated by 180 degree by the rotation apparatus 337 (FIG. 7(b)). By doing so, the irradiation surface of the laser beam 103 is reversed, and a second surface 345, which is flat, is supplied as an irradiation surface of the laser beam 103. During this period, the irradiation with the laser beam 103 is at rest.

Then, the second surface 345 is irradiated with the laser beam 103. Also, at the same time, the milling cutter 339 is rotated to flatten the first surface 343. Since the milling cutter 339 rotates at a predetermined position within the production chamber 107, the first surface 343 can be cut while moving the position of cutting with the milling cutter 339 by applying the laser beam 103 while moving the graphite plate 335 in the surface direction of the second surface 345. The cut dust of the graphite plate 335 generated by the milling cutter 339 is collected into the cut graphite collecting chamber 121, and is separated from the generated carbon nanohorn aggregates 117 that are collected into the nanocarbon collecting chamber 119.

In this embodiment, the condition for irradiation with the laser beam 103 can be made similar to that of the first embodiment. Also, the moving speed for translation movement of the graphite plate 335 while applying the laser beam 103 to the surface of the graphite plate 335 is set to be, for example, 0.4 mm/min or more and 4.8 mm/min or less. By setting the moving speed to be 4.8 mm/min or less, the surface of the graphite plate 335 can be irradiated with the laser beam 103 with certainty. Also, by setting the moving speed to be 0.4 mm/min or more, the carbon nanohorn aggregates 117 can be efficiently produced.

In the nanocarbon production apparatus 341, the irradiation surface of the laser beam 103 can be reversed, so that the two surfaces of the graphite plate 335 are alternately irradiated with the laser beam 103. Also, after irradiation with the laser beam 103, the surface is flattened by the milling cutter 339 and then subjected to irradiation again. For this reason, the fluctuation of the power density of the laser beam 103 on the irradiation surface can be restrained. Therefore, carbon nanohorn aggregates 117 having predetermined properties can be stably produced at a high yield.

By using the nanocarbon production apparatus according to the above-described embodiment, the graphite rod 101 side surface irradiated with the laser beam 103 can be flattened and subjected to the laser beam 103 irradiation again, so that also in the production of carbon nanotubes, these can be produced stably in a large amount.

Here, the shape, the size of the diameter, the length, the shape of the tip end part, the interval between carbon molecules or carbon nanohorns, and the like of the carbon nanohorns constituting the carbon nanohorn aggregates 117 can be controlled in various ways by the condition of irradiation with the laser beam 103 and the like.

As shown above, the present invention has been described on the basis of the embodiments. These embodiments are exemplary, and it is understood by those skilled in the art that various modifications can be made, and such modifications are also within the scope of the present invention.

For example, the carbon nanohorn production apparatus described in the above embodiments may have a controlling unit for controlling the irradiation with the laser beam 103, the movement or rotation of the graphite target, or the driving of the cutting tool or milling cutter.

Also, the above description is given taking as an example a case in which carbon nanohorn aggregates are produced as nanocarbon; however, the nanocarbon produced by using a production apparatus according to the above embodiments is not limited to carbon nanohorn aggregates.

For example, carbon nanotubes can be produced as well with the use of the production apparatus of FIG. 1. In the case of producing carbon nanotubes, it is preferable to adjust the output power, the spot diameter, and the irradiation angle of the laser beam 103 so that the power density of the laser beam 103 on the side surface of the graphite rod 101 is approximately constant, for example, 50±10 kW/cm².

Also, a catalyst metal is added to the graphite rod 101, for example, at 0.0001 wt % or more and 5% or less. As the metal catalyst, for example, a metal such as Ni or Co may be used.

### EXAMPLE

In this Example, carbon nanohorn aggregates 117 were produced with the use of the nanocarbon production apparatus having a configuration shown in FIG. 1.

A sintered round-rod carbon having a diameter of 100 mm and a length of 250 mm was used as the graphite rod 101, and this was fixed to the rotation apparatus 115 in the production chamber 107. After the gas in the production chamber 107 was discharged to reduce the pressure to 10⁻³ Pa, Ar gas was introduced to attain an atmosphere pressure of 10⁵ Pa. Subsequently, the graphite rod 101 was rotated at a rotation number of 6 rpm at room temperature, and the side surface thereof was irradiated with the laser beam 103 while moving it horizontally at 0.3 mm/sec.

A high-output-power CO₂ laser beam was used as the laser beam 103, and continuous oscillation was made with an output power of 3 to 5 kW, a wavelength of 10.6 μm, and a pulse width of 5 sec. Also, the angle formed by the horizontal plane and the line segment connecting the irradiation position to the center of the circle in a cross section perpendicular to the length direction of the graphite rod 101, that is, the irradiation angle, was set to be 45 degree, and the power density on the side surface of the graphite rod 101 was set to be 20 kW/cm²±10 kW/cm².

The obtained soot-like substance was subjected to TEM observation. Also, by the Raman spectroscopy, the strengths at 1350 cm⁻¹ and 1590 cm⁻¹ were compared to calculate the yield of the carbon nanohorn aggregates 117.

Subsequently, the side surface of the graphite rod 101 flattened by the cutting tool 105 was irradiated with the laser beam 103 for the second time, and the yield of the carbon nanohorn aggregates 117 was determined by the above-described method. Further, the position subjected to the second time irradiation was further subjected to third time irradiation to evaluate the product in the same manner.

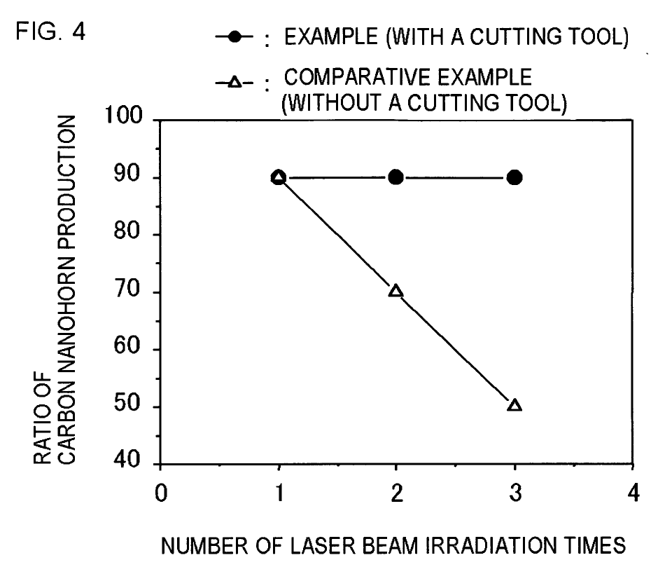

The obtained soot-like substance was observed with a transmission electron microscope (TEM), with the result that the carbon nanohorn aggregates 117 were dominantly produced by any of the first to third time irradiations, and the particle diameter thereof was within a range from 80 nm to 120 nm. Also, the yield of the carbon nanohorn aggregates 117 in the total substance obtained after the first to third time irradiations was determined by the Raman spectroscopy, giving a high yield of 90% or more in all the cases as shown in FIG. 4.

Therefore, in this Example, the carbon nanohorn aggregates 117 were obtained at a high yield by cutting the side surface of the graphite rod irradiated with the laser beam 103 using the cutting tool 105 and applying the laser beam 103 again. Also, it was made clear that this process is a continuous process suitable for mass production of carbon nanohorn aggregates.

### COMPARATIVE EXAMPLE

In the apparatus of FIG. 1, production of carbon nanohorn aggregates 117 was carried out without the use of the cutting tool 105. The production was carried out in the same manner as in the Example except that the side surface of the graphite rod 101 was not cut with the cutting tool 105.

As a result of this, according as the number of irradiation times with the laser beam 103 on the same graphite rod 101 increases, the yield of the carbon nanohorn aggregates considerably decreased, as shown in FIG. 4. So, the side surface after the first time irradiation with the laser beam 103 was observed by the naked eye, and it was found out that a concaved part having a depth of about 3 mm was formed at the position of irradiation with the laser beam 103, and the side surface of the concaved part was also roughened to a greater extent than the side surface before the irradiation. Therefore, it seems that, since the side surface having a concaved part formed therein is irradiated with the laser beam 103 again, the incidence angle and the power density of the laser beam 103 is changed, leading to decrease in the yield of the carbon nanohorn aggregates 117.

1. A nanocarbon production apparatus comprising:
a light source for irradiating a surface of a graphite target with light;
a surface processing unit for flattening the surface of said graphite target irradiated with light; and
a collecting unit for collecting carbon vapor evaporated from the graphite target by irradiation with light, as nanocarbon.

2. A nanocarbon production apparatus comprising:
a target holding unit that holds a graphite target having a cylindrical shape and rotates said graphite target around a central axis;
a light source for irradiating a surface of said graphite target with light;
a surface processing unit for flattening the surface of said graphite target irradiated with light; and
a collecting unit for collecting carbon vapor evaporated from said graphite target by irradiation with light, as nanocarbon.

3. A nanocarbon production apparatus comprising:
a target holding unit that holds a graphite target having a flat plate shape and rotates said graphite target by 180 degrees in a normal line direction of a surface;
a light source for irradiating a surface of said graphite target with light;
a surface processing unit for flattening the surface of said graphite target irradiated with light; and
a collecting unit for collecting carbon vapor evaporated from said graphite target by irradiation with light, as nanocarbon.

4. The nanocarbon production apparatus according to claim 1, further comprising movement unit that moves a relative position of said graphite target relative to said light source.

5. The nanocarbon production apparatus according to claim 1, wherein said surface processing unit removes a part of the surface of said graphite target at a position different from the irradiation position of said light.

6. The nanocarbon production apparatus according to claim 5, further comprising dust collecting unit for collecting dust of said graphite target generated in said surface processing unit.

7. The nanocarbon production apparatus according to claim 1, wherein said nanocarbon is carbon nanohorn aggregates.

8. A nanocarbon production method comprising:
irradiating a surface of a graphite target with light, collecting carbon vapor evaporated from said graphite target as nanocarbon, and flattening the surface of said graphite target irradiated with light; and
irradiating said surface that is flattened with light again and collecting carbon vapor evaporated from said graphite target as nanocarbon.

9. A nanocarbon production method comprising:
irradiating a surface of a graphite target having a cylindrical shape with light while rotating said graphite target around a central axis, collecting carbon vapor evaporated from said graphite target as nanocarbon, and flattening the surface of said graphite target irradiated with light; and
irradiating said surface that is flattened with light again while rotating said graphite target around the central axis, and collecting carbon vapor evaporated from said graphite target as nanocarbon.

10. A nanocarbon production method comprising:
irradiating a surface of a graphite target having a flat plate shape with light and collecting carbon vapor evaporated from said graphite target as nanocarbon;
flattening said surface of said graphite target irradiated with light after said graphite target irradiated with light is rotated by 180 degrees in a normal line direction of said surface; and
irradiating said flattened surface with light again and collecting carbon vapor evaporated from said graphite target as nanocarbon.

11. The nanocarbon production method according to claim 8, wherein irradiation with light is carried out while moving an irradiation position of light in said irradiating the surface of the graphite target with light and in said irradiating the graphite target surface with light again.

12. The nanocarbon production method according to claim 8, wherein said flattening the surface irradiated with light comprises removing a part of the surface of said graphite target.

13. The nanocarbon production method according to claim 8, wherein said irradiating the surface of said graphite target with light comprises irradiating with a laser beam.

14. The nanocarbon production method according to claim 8, wherein said collecting the nanocarbon comprises collecting carbon nanohorn aggregates.
